(19) United States
(12) Patent Application Publication
(10) Pub. No.: US 2008/0267144 A1
(43) Pub. Date: Oct. 30, 2008

(54) SYSTEM AND METHOD FOR MANAGING BROADCAST AND/OR MULTICAST BASED COMMUNICATION SESSIONS FOR MOBILE NODES

(75) Inventors: Bashar Jano, Algonquin, IL (US); James J. Morikuni, Itasca, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/740,401

(22) Filed: Apr. 26, 2007

(51) Int. Cl. H04Q 7/24

(52) U.S. Cl. 370/338

(57) ABSTRACT

A system (100) and method for managing communication session is provided. The system includes a mobile node (104) that is communicably coupled to a first communication network (102). Further, the system includes a first proxy-relay (108). The first proxy-relay is communicably coupled to the first communication network and performs one or more functions on behalf of the mobile node. The system also includes a first policy-profile repository (106) that is communicably coupled to the first communication network. The first policy-profile repository stores a first set of policy-profile definitions describing a first set of services in the first communication network that the mobile node is allowed to access and a first set of rules describing discovery preferences for the mobile mode.

### FIELD OF THE INVENTION

This invention relates in general to communication networks, and more specifically, to a system and method for managing communication sessions in one or more communication networks.

### BACKGROUND OF THE INVENTION

Seamless mobility envisions a mobile node (for example, a mobile phone, a Personal Digital Assistant (PDA), a laptop computer, or the like) interacting with and controlling other devices within networks such as Personal Area Networks (PANs) and Local Area Networks (LANs). There are efforts to use Universal Plug and Play (UPnP), Internet Engineering Task Force (IETF) Zero Configuration Networking, and so forth to realize seamless mobility.

UPnP uses ad-hoc network configuration and multicast messages to enable a node (such as a mobile node) to join a network and discover and interact with other nodes in the network. Typically, a mobile node sends a multicast message announcing its availability and characteristics when it joins the network. Nodes in the network that are listening for such multicast messages then become aware of the mobile node. A node in the network that wants to find other nodes to fulfill a function sends a multicast message describing its needs to the network. Listening nodes in the network then may reply to the multicast message and offer to fulfill one or more of the needs.

In existing technologies, a mobile node expends energy and resources processing broadcast and multicast messages. While a mobile node is not actively communicating, it may conserve energy by shutting down, slowing down, or hibernating some of its functions and processes. The mobile node will re-activate some of its functions and processes to prepare to receive an inbound communication (for example, a message from another node in the network to the mobile node). A mobile node on a network is supposed to receive all broadcast messages and all relevant multicast messages. Because broadcast and multicast messages do not target a specific device, often a broadcast or multicast message is of no interest to the mobile node yet the mobile node must re-activate many of its functions and processor(s) in order to receive and analyze the inbound message to determine if it is of interest. As a consequence, a network frequently using broadcast or multicast messages causes a mobile node in the network to consume more energy than the energy required to perform its normal functions in the absence of the broadcast or multicast messages.

### BRIEF DESCRIPTION OF THE FIGURES

The accompanying figures, where like reference numerals refer to identical or functionally similar elements throughout the separate views, and which, together with the detailed description below, are incorporated in and form part of the specification, serve to further illustrate various embodiments as well as explain various principles and advantages, all in accordance with the present invention.

FIG. 1 is a block diagram illustrating a system for managing communication sessions, in accordance with a first embodiment;

FIG. 2 shows a flow diagram depicting a method for a proxy-relay to establish a communication session in a communication network on behalf of a mobile node, in accordance with the first embodiment;

FIG. 3 is a block diagram illustrating a policy-profile repository, in accordance with various embodiments of the present invention;

FIG. 4 shows a call-flow diagram for managing communication sessions, in accordance with the first embodiment;

FIG. 5 is a block diagram illustrating a system for managing communication sessions, in accordance with a second embodiment;

FIG. 6 shows a call-flow diagram, in accordance with the second embodiment;

FIG. 7 is a block diagram illustrating a system, in accordance with a third embodiment; and

FIG. 8 shows a call-flow diagram depicting a mobile node facilitating a brokering service, in accordance with the third embodiment.

Skilled artisans will appreciate that elements in the figures are illustrated for simplicity and clarity and have not necessarily been drawn to scale. For example, the dimensions of some of the elements in the figures may be exaggerated relative to other elements, to help in improving an understanding of the embodiments. Elements in the figure may represent logical entities that represent functional roles which have no physical dimensions. Those with ordinary skills in the art will recognize that different logical entities (such as a security policy repository and a policy-profile repository) may be combined on a single physical entity (such as a PDA, a mobile phone, a home computer, and the like). Those with ordinary skills in the art will further recognize that logical entities may be replicated and/or distributed among one or more physical entities.

Those skilled in the art will appreciate that the further embodiments may include all or even a fewer number of components than shown in the figures. Further, those of ordinary skill in the art will understand that the various embodiments may include additional components that are not shown here.

### DETAILED DESCRIPTION

Before describing in detail the method and system for managing communication sessions, in accordance with the present invention, it should be observed that the present invention resides primarily in combinations of method steps and system components related to a method and a system for managing communication sessions in one or more communication networks. Accordingly, the system components have been represented where appropriate by conventional symbols in the drawings, showing only those specific details that are pertinent for an understanding of the present invention, so as not to obscure the disclosure with details that will be readily apparent to those with ordinary skill in the art, having the benefit of the description herein.

In an embodiment, a system for managing communication sessions includes a mobile node that is communicably coupled to a communication network. The communication network communicably couples to a proxy-relay that performs one or more functions on behalf of the mobile node. The communication network also couples to a policy-profile repository that stores a set of policy-profile definitions. The policy-profile definitions describe a set of services of interest to, or offered by, the mobile node, and a set of rules describing discovery preferences. The rules describing discovery preferences include, but are not limited to, rules for the proxy-relay regarding offering responses to queries pertaining to services provided by the mobile node, rules for the proxy-relay regarding initiating service announcements for services offered by the mobile node, rules for the proxy-relay regarding initiating service queries pertaining to services of interest to the mobile node, and rules the proxy-relay regarding identifying which services notifications the proxy-relay should forward to the mobile node and which ones the proxy-relay should block.

In another embodiment, a policy-profile repository includes an interface to a communication network and a non-volatile memory for storing a set of policy-profile definitions corresponding to a set of mobile nodes. The policy-profile definitions describe a set of services of interest to, or offered by, the mobile node, and a set of rules describing discovery preferences.

In yet another embodiment, a method for a proxy-relay of a communication network manages at least one communication session in one or more communication networks. The method includes establishing a unicast communication session between a mobile node and the proxy-relay. Further, the method includes obtaining one or more policy-profile definitions from either the mobile node or a policy-profile repository, or some combination there of. The policy-profile definitions describe one or more services of interest to, or offered by, the mobile node, and a set of rules describing discovery preferences. At this point, the mobile node can disable its multicast and broadcast interfaces because the proxy-relay then performs one or more functions on behalf of the mobile node in conformance with the one or more policy-profile definitions.

In several embodiments, a proxy-relay improves the mobile node's energy consumption by blocking unnecessary broadcast and multicast messages from reaching the mobile node and by negotiating communication sessions setup with other nodes without involving the mobile node. The mobile node is involved only when a communication session of relevance to the mobile is detected by the proxy-relay. For example, the system will effectively block all messages that are of no interest or do not apply to the mobile node as determined using policy-profile definitions. Among the queries that can be serviced by the mobile node, the mobile node is contacted only after the service requester (for example, a first node) selects the mobile node to fulfill a service. In this situation, the mobile node is not contacted if the requester chooses an alternate service provider (for example, a second node). The mobile node in this system is able to remain in a lower power consumption state longer when compared to a system that intends all broadcast and all applicable multicast messages, plus all applicable unicast message, to reach the mobile node.

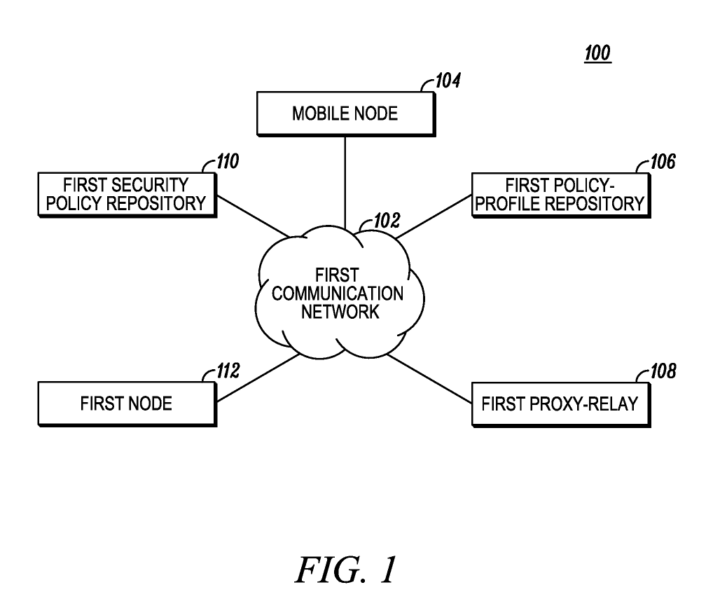

FIG. 1 is a block diagram illustrating a system for managing communication sessions, in accordance with a first embodiment. The system 100 includes a first communication network 102. The communication network 102 may be geographically spread over an area such as a building. Examples of the communication network 102 include a Local Area Network (LAN) and a Personal Area Network (PAN). The system 100 also includes a mobile node 104, a first policy-profile repository 106, a first proxy-relay 108, and a first security policy repository 110. The system 100 may also include one or more other nodes, for example, a first node 112.

The mobile node 104 is communicably coupled with the communication network 102. Implementations of the mobile node 104 include, but are not limited to, mobile phones, mobile computers, two-way radios, pagers, and Personal Digital Assistants (PDAs). The first proxy-relay 108 can be discovered by the mobile node 104 by using service and node discovery protocols, such as Universal Plug and Play (UPnP), Internet Engineering Task Force (IETF) Zero Configuration Networking, and so forth. In this embodiment, after the proxy-relay 108 is discovered and a unicast communication session established between the mobile node 104 and the proxy-relay 108, the mobile node 104 delegates one or more of its functions to the proxy-relay 108 through informing the proxy-relay 108 about a first set of policy-profile definitions applicable to the mobile node 104.

The policy-profile definitions describe a first set of services of interest to, or offered by, the mobile node 104 and a first set of rules describing discovery preferences. Examples of the services include printing service, storage service, and so forth. Examples of rules describing discovery preferences include rules for the proxy-relay regarding offering responses to queries pertaining to services provided by the mobile node, rules for the proxy-relay regarding initiating service announcements for services offered by the mobile node, rules for the proxy-relay regarding initiating service queries pertaining to services of interest to the mobile node, and rules the proxy-relay regarding identifying which services notifications the proxy-relay should forward to the mobile node and which ones the proxy-relay should block.

To inform the proxy-relay 108 regarding applicable policy-profile repository 106 definitions, the mobile node 104 can send a policy-profile reference to the proxy-relay 108. This policy-profile reference corresponds to one or more policy-profile definitions stored in the policy-profile repository 106. In an embodiment, the policy-profile reference is a Hypertext Transfer Protocol (HTTP) Uniform Resource Locator (URL) corresponding to a policy-profile definition. In an alternate embodiment, the mobile node 104 sends policy-profile definitions directly to the proxy-relay 108 without using an intermediate policy-profile reference.

The policy-profile repository 106 stores a first set of policy-profile definitions and can be communicably coupled to the communication network 102. In an embodiment, the policy-profile definitions are expressed by using eXtensible Markup Language (XML). In the embodiment shown, the policy-profile repository 106 is an independent node in the communication network 102. In an alternate embodiment, the policy-profile repository 106 is co-located with the proxy-relay 108. In another embodiment, the policy-profile repository 106 resides on the mobile node 104. In yet another embodiment, policy-profiles are stored in the policy-profile repository 106, the mobile node 104, and the proxy-relay 108. In this case, some of the policy-profile definitions may be stored by each of the elements. Those skilled in the art will recognize that policy-profile definitions fragmented and distributed among the mobile node and policy-profile repositories may be aggregated at the proxy-relay, or they may be aggregated by another agent (such as the mobile node, an auxiliary policy-profile repository, or the like) before delivery to the proxy-relay 108.

As previously mentioned, after the proxy-relay 108 is aware of the policy-profiles applicable to a mobile node 104, the proxy-relay 108 performs one or more functions at the communication network 102 on behalf of a mobile node 104. Examples of these one or more functions include, but are not limited to, informing the communication network 102 about the services that the mobile node 104 is interested to access from the communication network 102 and/or the services offered by the mobile node 104. Note that when the proxy-relay 108 is not able to use the policy-profile repository 106, the mobile node 104 may be assigned a null policy-profile definition that instructs the proxy-relay 108 to forward all network broadcast and unicast messages from/to the network 102 over a unicast communication session between the mobile node 104 and the proxy-relay 108. Alternately, the proxy-relay 108 can dynamically generate a set of policy-profile definitions after establishing a unicast communication session with the mobile node 104. This dynamic generation is based on observing and retaining in non-volatile memory a list of the services that the mobile node 104 requests to access and/or the services that the mobile node offers to the communication network 102 which the proxy-relay 108 can use to infer a policy-profile definition for the mobile node 104.

The proxy-relay 108 receives notification messages from the communication network 102 regarding services offered by other nodes, such as the node 112, associated with the communication network 102. Sometimes, the proxy-relay 108 includes a cache to store policy-profile definitions fetched by it from the policy-profile repository 106. In an embodiment, the proxy-relay 108 also stores the notification messages received from the communication network 102 regarding services offered by the other nodes, such as the node 112. Typically, the proxy-relay 108 stores the notification messages for a first predefined time period. In an embodiment, when the mobile node 104 reactivates after a lower power consumption period, the proxy-relay 108 processes the stored notifications according to the applicable policy-profile definitions and forwards messages to/from the mobile node 104 accordingly.

In an embodiment, the proxy-relay 108 determines a threshold for the mobile node 104 that defines the maximum number of activities the mobile node 104 is capable of participating in. Examples of these activities include the sessions the mobile node 104 can simultaneously participate in. The threshold can be based on factors that include: the processing power of the mobile node 104, its storage capacity, its battery level, the bandwidth available to the mobile node 104, and others. Typically, the threshold is determined based on the policy-profile definitions and can be the modified by the mobile node 104. Alternately, the threshold can be part of the policy-profile definitions and stored in the policy-profile repository 106.

The proxy-relay 108 then determines a load factor of the mobile node 104, which indicates the number of activities the mobile node 104 is participating in. The proxy-relay 108 regulates the rate of sending notifications to the mobile node 104 based on the load factor. Typically, the proxy-relay 108 forwards notification messages to the mobile node 104 when the load factor is less than the threshold. For example, the proxy-relay 108 can stop sending notifications to the mobile node 104 when the load factor exceeds the threshold. The actions to take based on load factor can be part of the policy-profile definitions and stored in the policy-profile repository 106.

The mobile node 104 can suspend one or more policy-profile definitions or add new policy-profile definitions. For example, the mobile node 104 can reduce the rate at which network notifications are received by adjusting a policy-profile definition. In another situation, the mobile node 104 can modify the policy-profile definitions to receive notifications about high-priority events. For example, the mobile node 104 can modify its policy-profile definitions to receive notifications corresponding only to high-priority events when its battery level drops below a pre-defined level. In this situation, the mobile node 104 can send details about its battery level to the proxy-relay 108 over a unicast communication session. Then, in accordance with the current policy-profile definitions, the proxy-relay 108 regulates its interaction with the mobile node 104, based on the reported battery level. In another embodiment, the proxy-relay 108 regulates the notifications sent to the mobile node 104 based on parameters such as voice call active, signal quality, and so forth.

The security policy repository 110 is also communicably coupled to the communication network 102 and stores a first set of security policies which correspond to the mobile node 104 and the communication network 102. The security policy repository 110 may implement an UPnP Security Console Service (or a similar service). Security policies are used to authenticate the mobile node 104 when the node is inside the communication network 102, or when the node is accessing the communication network 102 from any remote communication network. Typically, a first set of security policies includes an access control list describing the services the mobile node 104 is allowed to access via the communication network 102. Typically, the security policy repository 110 provides authentication and encryption services in the communication network 102. The security policy repository 110 can additionally provide tunneling services between the communication network 102 and the mobile node 104 when the mobile node 104 is in another communication network.

The security policy repository 110 limits what services the mobile node 104 may access from or offer to other nodes (such as the node 112) coupled to the communication network 102. For example, when the mobile node 104 that belongs to an owner of a home is in the owner's home network (such as a home LAN), security policy repository 110 allows the mobile node 104 to access all the services in the home network. Alternately, when the mobile node 104 is in an office network (such as an office LAN), the security policy repository 110 allows the mobile node 104 to access, for example, a printer and a storage device, but not a plotter. Typically, the mobile node 104 can be allowed to access the services based on the whether the mobile node 104 is recognized as an administrator, a friend, a guest, a child, or other category defined in the communication network 102.

As stated previously, the first node 112 is associated with the communication network 102; the first node is merely an example of many other nodes that may be associated with the communication network 102. Examples of the node 112 include, but are not limited to, computers, printers, scanners, mobile phones, Internet Protocol (IP) phones, CD jukeboxes, set top boxes, and the like. Typically, the node 112 offers or subscribes to at least one service of the communication network 102. The node 112 can also use a service offered by the mobile node 104.

In an embodiment, the mobile node 104, establishes a unicast communication session with the proxy-relay 108 and disables its broadcast and multicast interfaces and thus stops monitoring broadcast/multicast channels for service notifications. Instead, the proxy-relay 108 monitors the broadcast/multicast channels on behalf of the mobile node 104. In this situation, the proxy-relay 108 uses policy-profile definitions to determine when a service announcement is relevant to the mobile node 104. When the proxy-relay 108 determines that a notification is of interest to the mobile node 104, it notifies the mobile node 104 via a unicast communication session that is established over the communication network 102. In another embodiment, the proxy-relay 108 does not notify the mobile node 104 of an applicable notification upon receipt of said notification. Instead, the proxy-relay 108 notifies the requester (for example, the node 112) of the mobile node's availability. The proxy-relay 108 then only notifies the mobile node 104 when the requester chooses the mobile node 104 to fulfill the service and sends a message announcing the selection.

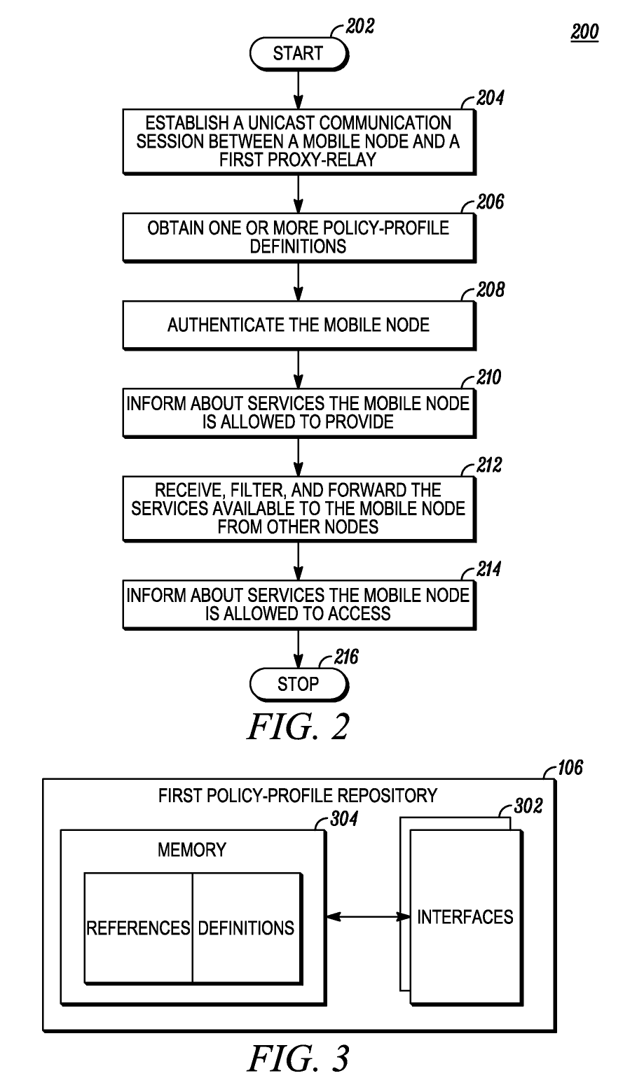

FIG. 2 shows a flow diagram depicting a method 200 for a proxy-relay 108 to establish a communication session in the communication network 102 on behalf of the mobile node 104, in accordance with the first embodiment. To describe the method 200, reference will be made to FIG. 1, although it should be understood that the method 200 can be implemented in any suitable environment or network. Moreover, the invention is not limited to the order in which the steps are listed in the method 200.

At step 202, the method for managing a communication session is initiated. At step 204, the mobile node 104 establishes a unicast communication session between the mobile node 104 and the proxy-relay 108. Typically, the mobile node 104 discovers the proxy-relay 108 through broadcast or multicast messages, and after the proxy-relay 108 is discovered, a unicast communication session is established between the mobile node 104 and the proxy-relay 108 via the communication network 102. In an embodiment, the mobile node 104 carries out negotiations regarding the capabilities of the proxy-relay 108 before establishing the unicast communication session with the proxy-relay 108. Examples of the capabilities include the storage capacity of the cache of the proxy-relay 108, the cache refresh rate, and so forth.

In an embodiment, the mobile node 104 then provides policy-profile references to the proxy-relay 108 that correspond to a policy-profile definition in the set of policy-profile definitions stored within the policy-profile repository 106. Typically, the mobile node 104 suspends or severs the unicast communication session with the proxy-relay 108 after providing the one or more policy-profile references. In another embodiment, the mobile node 104 does not suspend or sever the communication session with the proxy-relay 108. In yet another embodiment, the communication session is maintained for a predefined time period during which the probability of communication is high. Thereafter, the communication session is suspended or severed.

At step 206, the proxy-relay 108 obtains one or more policy-profile definitions (that correspond to the policy-profile references received from the mobile node 104), from the policy-profile repository 106. These policy-profile definitions describe the services in the communication network 102 that the mobile node 104 is interested to access or can offer to other nodes as well as rules describing discovery preferences for the mobile node 104.

At step 208, the proxy-relay 108 and the mobile node 104 authenticate each other. The proxy-relay 108 offers its credentials to the mobile node 104, and vice versa, and interacts with the security policy repository 110 according to common practices known to those skilled in the art. Thereafter, at steps 210, 212, and 214, the proxy-relay 108 performs one or more functions on behalf of the mobile node 104. At step 210, the proxy-relay 108 informs other nodes in the communication network 102 about the services the mobile node 104 is allowed to provide (based on the policy-profile definitions and security profile definitions).

At step 212, the proxy-relay 108 receives one or more broadcast or multicast notification messages from the communication network 102 regarding the services offered by the other nodes associated with the communication network 102. The proxy-relay 108 then filters and identifies a first notification message from the one or more broadcast or multicast notification messages. The first notification message corresponds to a service the mobile node 104 is interested in or can provide (based on its policy-profile definitions) and which it is allowed to access or provide (based on its security profile definitions). Thereafter, the proxy-relay 108 forwards the notification message to the mobile node 104 using a unicast communication session.

If the communication session between the mobile node 104 and the proxy-relay 108 is severed, a new unicast communication session is established between the proxy-relay 108 and the mobile node 104 to provide the notification message information to the mobile node 104. At step 214, the proxy-relay 108 informs the communication network 102 about the services the mobile node 104 is allowed to access (based on its policy-profile definitions and its security profile definitions) in the communication network 102. Typically, the proxy-relay 108 sends a broadcast or multicast message to the communication network 102 to inform about the services that the mobile node 104 is allowed to access. Thereafter, the method terminates at step 216. At this point, the proxy-relay 108 has established a presence for the mobile node 104 in the communication network 102, and the mobile node 104 is allowed to ignore broadcast and multicast messages and enter a power saving state for a predetermined period of time.

FIG. 3 is a block diagram illustrating a policy-profile repository 106, in accordance with various embodiments of the present invention. The policy-profile repository 106 includes one or more interfaces 302 and a memory 304. The interfaces 302 typically include a unicast interface and a broadcast and/or multicast interface and enable the policy-profile repository 106 to interact with a communication network, such as the communication network 102. The interfaces 302 are communicably coupled to the memory 304. The non-volatile memory 304 stores a first set of references and a first set of policy-profile definitions corresponding to a first set of mobile nodes. When a mobile node 104 needs to access a new service, it adds a new policy-profile definition, corresponding to the new service, to the set of policy-profile definitions stored at the policy-profile repository 106. In an embodiment, the memory 304 includes security measures such as, but not limited to, security credentials and encryption techniques to prevent unintended access and manipulation of the policy-profile definitions. Those skilled in the art will recognize that memory and the data stored may be organized in various ways to optimize access, improve redundancy, and/or maintain integrity of the data.

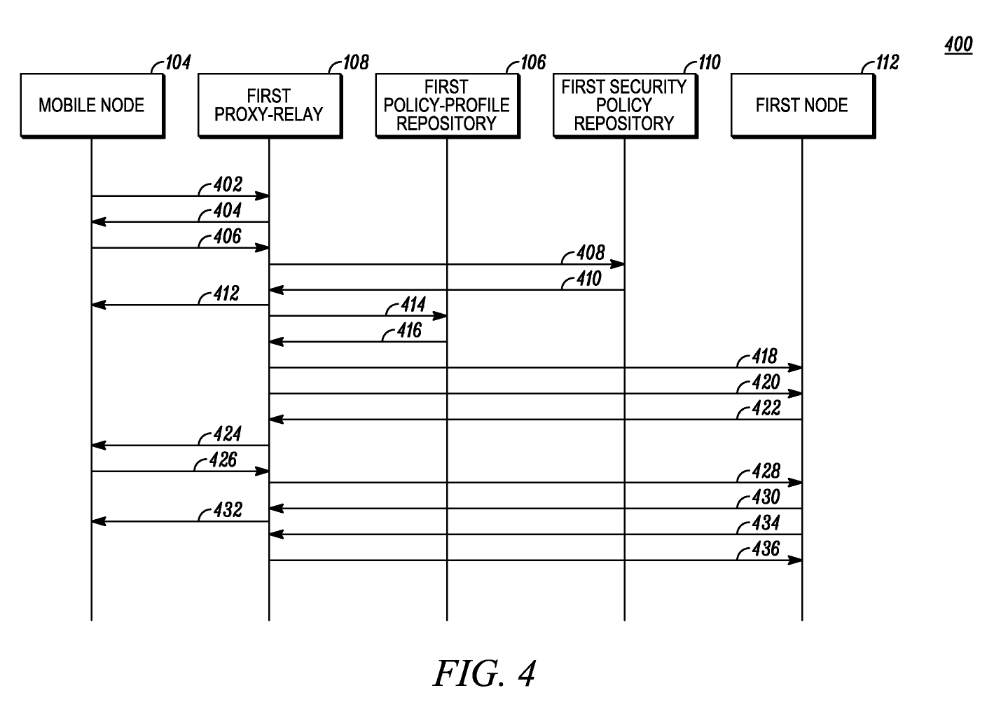

FIG. 4 shows a call-flow diagram 400 for managing communication sessions, in accordance with a first embodiment. After entering within communication range of the communication network 102, the mobile node 104 discovers the proxy-relay 108. In an embodiment, the mobile node 104 can discover the proxy-relay 108 by using UPnP protocol. In an alternate embodiment, the mobile node 104 discovers the proxy-relay 108 by using a preconfigured logical address with a Domain Name Server (DNS) or an entry in a Dynamic Host Configuration Protocol (DHCP) server (not depicted). In another embodiment, the address of the proxy-relay 108 is preconfigured on the mobile node 104. In yet another embodiment, the address can be a cached copy (or a learned copy) of an address discovered during a previous communication session establishment.

After discovering the proxy-relay 108, the mobile node 104 can establish a new profile and/or modifies its existing profiles using a policy-profile repository 106 so that the proxy-relay 108 interacts with the mobile node 104 in accordance with the preferences of the mobile node 104. In this example, the mobile node 104 determines a policy-profile reference corresponding to its policy-profile definitions. Typically, the policy-profile reference is a Hypertext Transfer Protocol Uniform Resource Locator (HTTP URL). In another embodiment, the policy-profile reference corresponds to a policy-profile-definition from a set of policy-profile definitions. Typically, policy-profile definitions are expressed by using XML.

After joining the communication network 102, the mobile node 104 establishes a unicast communication session with the proxy-relay 108. The messages 402 to 412 depict discovering a proxy-relay 108 and establishing a unicast communication session and relate to step 204 of FIG. 2. The mobile node 104 broadcasts or multicasts a search message 402 to the communication network 102 to search for a proxy-relay. On receiving the search message 402, the proxy-relay 108 responds by sending a service announcement message 404 to the mobile node 104. The service announcement message 404 includes the address of the proxy-relay 108 and a list of services offered by the proxy-relay 108.

Upon receiving the service announcement message 404, the mobile node 104 sends a session request message 406 to the proxy-relay 108. The session request message 406 includes the preferences of the mobile node 104 for a unicast communication session. Examples of preferences include the Quality of Service (QoS) expected by the mobile node 104 and the maximum number of communication sessions that can be handled by the proxy-relay 108 for the mobile node 104.

Upon receiving the session request message 406, the proxy-relay 108 sends a check-policy message 408 to the security policy repository 110 to authenticate the mobile node 104 and to establish the set of services accessible to and provided by the mobile node 104 according to applicable security policies. The security policy repository 110 sends a service response 410 indicating successful authentication of the mobile node 104. After authenticating the mobile node 104, the proxy-relay 108 sends a session established message 412 to the mobile node 104. Note that authentication can occur during session establishment (as shown in FIG. 4) or after session establishment (as shown in step 208 in FIG. 2).

Generally, after the unicast communication session is established between the mobile node 104 and the proxy-relay 108, the mobile node 104 disables its broadcast and multicast interfaces and stops processing messages broadcast or multicast from the communication network 102. In another embodiment, immediately after the mobile node 104 discovers the proxy-relay 108, the mobile node 104 stops listening to messages broadcast or multicast from the communication network 102. In yet another embodiment, after discovering the proxy-relay 108 by using a DNS or a DHCP server, the mobile node 104 does not listen to the messages broadcast or multicast from the communication network 102.

Typically, during or after establishing the unicast communication session, the proxy-relay 108 obtains the policy-profile definitions for the mobile node 104. Messages 414 and 416 depict the obtaining of the policy-profile definitions and relate to step 206 of FIG. 2. The mobile node 104 sends the policy-profile definitions and/or policy-profile references to the proxy-relay 108 in the session request message 406. If the proxy-relay 108 receives policy-profile references from the mobile node 104, the proxy-relay 108 sends a fetch message 414 to the policy-profile repository 106 to fetch the applicable policy-profile definitions. Alternately, the proxy-relay 108 fetches the policy-profile definitions from the cache of the proxy-relay 108 or from other location(s). Typically, the proxy-relay 108 fetches the policy-profile definitions from the policy-profile repository 106 when an up-to-date copy of the policy-profile definitions is not present in the cache of the proxy-relay 108.

Upon receiving the fetch message 414, the first policy-profile repository sends the policy-profile definition corresponding to policy-profile reference to the proxy-relay 108 in the form of a message 416. Optionally, the policy-profile repository 106 verifies the mobile node 104 and its access rights to the policy-profile definitions before policy-profile definitions are returned to the proxy-relay 108 via message 416.

After obtaining the policy-profile definitions from the message 416, the proxy-relay 108 performs one or more functions on behalf of the mobile node 104. Messages 418 to 424 depict the performing of these functions and relate to steps 210, 212, and 214 of FIG. 2. The proxy-relay 108 sends a broadcast or multicast offer message 418 to the communication network 102 that is relayed by the communication network 102 to the other nodes. The broadcast or multicast offer message 418 informs the other nodes in the communication network 102 about the services offered by the mobile node 104. For example, the mobile node 104 offers a music server to the communication network 102. In this example, the one or more services offered by the mobile node 104 include providing music to other nodes. Typically, the offer message 418 specifies details of an offered service. For example, the offer message 418 can specify that it offers a Moving Picture Experts Group Layer-3 Audio (MP3) music file.

The proxy-relay 108 also sends a broadcast or multicast access message 420 to the communication network 102. The broadcast or multicast access message 420 informs the communication network 102 about the services the mobile node 104 is allowed to access and interested in accessing. For example, a service the mobile node 104 is allowed to access can be a printing service, when the mobile node 104 needs a printer to print a document. Typically, the access message 420 specifies the details of the needed services. For example, the access message 420 can specify that the mobile node 104 needs a color printer to print a photograph.

After receiving an access message 420, another node 112 sends a notification message 422 to the proxy-relay 108 when it can provide a service that the mobile node 104 is allowed to access and interested in accessing. For example, if the node 112 is a printer that can provide a color-printing service to the mobile node 104, the node 112 sends the notification message 422 informing the proxy-relay 108 about the available service.

Typically, the proxy-relay 108 identifies a first notification message from multiple notification messages 422 pertaining to a service the mobile node 104 is allowed to access based on the policy-profile definitions of the mobile node 104. Thereafter, the proxy-relay 108 forwards the first notification message to the mobile node 104 in form of a message 424 using a unicast communication session.

In some embodiments, the policy-profile definition for the mobile node 104 does not permit the proxy-relay 108 to make a node selection for a requested service on behalf of the mobile node 104. In this case, the proxy-relay 108 forwards a plurality of response messages, in form of the message 424 to the mobile node 104. Then the mobile node 104 selects a node, based on the details of the node. In a variant of this embodiment, the message 424 merely indicates to the mobile node 104 that one or more nodes offering a requested service are present in the communication network 102. In this embodiment, the mobile node 104 sends a query to the proxy-relay 108 seeking details about the nodes offering the service at the point in time when the service is needed by the mobile node. Then the mobile node 104 selects a node, based on the given details about the nodes. Examples of details include the QoS offered by the nodes, location or proximity, favorable heuristics based on past interactions, and so forth. In an embodiment, the proxy-relay 108 fetches the details about the nodes from a cache. Typically, the proxy-relay 108 stores the details in its cache for a predefined time interval.

In another embodiment, the proxy-relay 108 buffers the notification messages (based on the policy-profile definitions), generates a batch message, which includes all the applicable notification messages 422, and sends the batch message 424 to the mobile node 104. In yet another embodiment, each notification message 422 is sent individually to the mobile node 104 using separate unicast messages 424. Those skilled in the art will recognize that the notification message 424 forwarded to the mobile node 104 may not include all the details found in the original notification messages 422 received by the proxy-relay 108. Implementation may reduce the size of the message 424 using compression techniques; and/or may eliminate details that are commonly known and shared between the mobile node 104 and the proxy-relay 108.

In another embodiment, the proxy-relay 108 stores all notification messages 422 received from the communication network 102 for a defined time period. In this situation, the proxy-relay 108 does not need to announce to the other nodes (such as the node 112) the services the mobile node 104 is allowed to and interested in accessing or send the broadcast or multicast message 420. Instead, the message 424 is generated by the proxy-relay 108 based on previous notifications to the proxy-relay 108.

If the proxy-relay 108 is unable to initiate a session with the mobile node 104, and only the mobile node 104 is able to initiate a session with the proxy-relay 108, and the unicast communication session between the mobile node 104 and the proxy-relay 108 has been severed, then the proxy-relay 108 signals the mobile node 104 to re-establish the communication session upon receiving a message 422 offering a service the mobile node 104 is allowed to access. The proxy-relay 108 can use a push message technique, for example, a Wireless Application Protocol (WAP) notification, a Short Message Service (SMS) message, and the like, to notify the mobile node 104 about the services. On receiving such notification, the mobile node 104 re-establishes the unicast communication session with the proxy-relay 108. Typically, the unicast communication session is based on protocols, for instance, connection-oriented protocols such as Transmission Control Protocol (TCP) or connectionless protocols such as User Datagram Protocol (UDP). In yet another embodiment, the mobile node 104 periodically polls the proxy-relay 108 for any pending messages 424. On detecting a pending message 424, the mobile node 104 determines whether there is a need to re-establish the unicast communication session between the mobile node 104 and the proxy-relay 108.

In certain situations, the mobile node 104 needs to discover a new service that has not been defined by it in the policy-profile definitions. For example, the mobile node 104 starts a Moving Picture Experts Group Layer-2 Audio (MP2) player and would like to access an MP2 renderer. In this embodiment, the mobile node 104 establishes a new unicast communication session with the proxy-relay 108. Thereafter, the mobile node 104 sends a new service search 426 to the proxy-relay 108. In another embodiment, the mobile node 104 adds a new policy-profile definition, corresponding to the new service, at the policy-profile repository 106 (via the proxy-relay 108). Thereafter, the mobile node 104 forwards a reference of the new policy-profile definition to the proxy-relay 108.

The proxy-relay 108 broadcasts or multicasts the new service search 426 in the form of a message 428 to the communication network 102. The proxy-relay 108 also adds the new policy-profile definition corresponding to the new service to policy-profile definitions of the mobile node 104. In this embodiment, the new policy-profile definition is added temporarily and does not persist across different communication sessions. In other words, the proxy-relay 108 deletes the newly-added policy-profile definition after severing the new unicast communication session. In an embodiment, the mobile node 104 provides a time-to-live value corresponding to the new policy-profile definition and the new policy-profile definition is deleted by the proxy-relay 108 upon the expiry of the time-to-live value.

Upon receiving the broadcast or unicast message 428 via the network 102 a node 112 may send a notification message 430 to the proxy-relay 108 communicating that it can provide the requested service (e.g., MP2 rendering) via the network 102. Upon receiving the notification message 430, the proxy-relay 108 updates its cache with an entry corresponding to the node 112 and the new service available. Thereafter, the proxy-relay 108 sends a unicast message 432 to the mobile node 104. Typically, the unicast message 432 notifies the mobile node 104 about the node 112. Thereafter, the mobile node 104 is able to establish a unicast communication session with the node 112 offering the service (not depicted in FIG. 4).

In another embodiment, the communications between the mobile node 104 and the node 112, are tunneled or relayed through the proxy-relay 108. In an embodiment, the proxy-relay 108 can perform protocol translation. For example, the node 112 uses a first protocol such as IETF's Zero Configuration Network technologies protocol; the mobile node 104 uses a second protocol such as UPnP. Thus, the proxy-relay 108 supports the first protocol as well as the second protocol. Typically, the proxy-relay 108 translates the first protocol to the second protocol, and vice versa, to facilitate interaction between the node 112 and the mobile node 104.

In another scenario, a requesting node, such as node 112, initiates the discovery of a service. For example, the node 112 sends a standard service discovery broadcast or multicast message 434 to the communication network 102. Upon receiving the service discovery message 434, the proxy-relay 108 determines whether a service offered by the mobile node 104 to the communication network 102 matches the service requested by the other node 112. The proxy-relay 108 responds to the service discovery broadcast or multicast message 434 on behalf of the mobile node 104 if it determines that the service requested by the node 112 matches a service offered by the mobile node 104. Typically, the proxy-relay 108 sends a response message 436 to the other node 112 including details of the mobile node 104. The response may include a pseudo Quality-of-Service (QoS) indication and/or the address of the mobile node 104. In an embodiment, the proxy-relay 108 sends a notification to the mobile node 104 before sending the response message 436 to the node 112. In another embodiment, the proxy-relay 108 responds to the service discovery broadcast/multicast message 434 in accordance with the policy definitions cached in the proxy-relay 108 without notifying the mobile node 104. In this case, messages are forwarded to the mobile node 104 if and when the node 112 chooses the mobile node 104 to fulfill the requested service.

The first embodiment, FIG. 1, FIG. 2, FIG. 3, and FIG. 4 define a system, methods, and examples that depict how to minimize the amount of energy a mobile node (or any node attempting to conserve energy or is otherwise unable or unwilling to monitor broadcast or multicast messages) needs to expend when participating in communication networks that are based on broadcast or multicast messages (such as UPnP and Zero Configuration Networking). The energy is minimized primarily by allowing the mobile node to ignore the broadcast and multicast messages and delegate handling of such messages to another node capable of monitoring and processing broadcast and multicast and non-broadcast/multicast messages over the communication network.

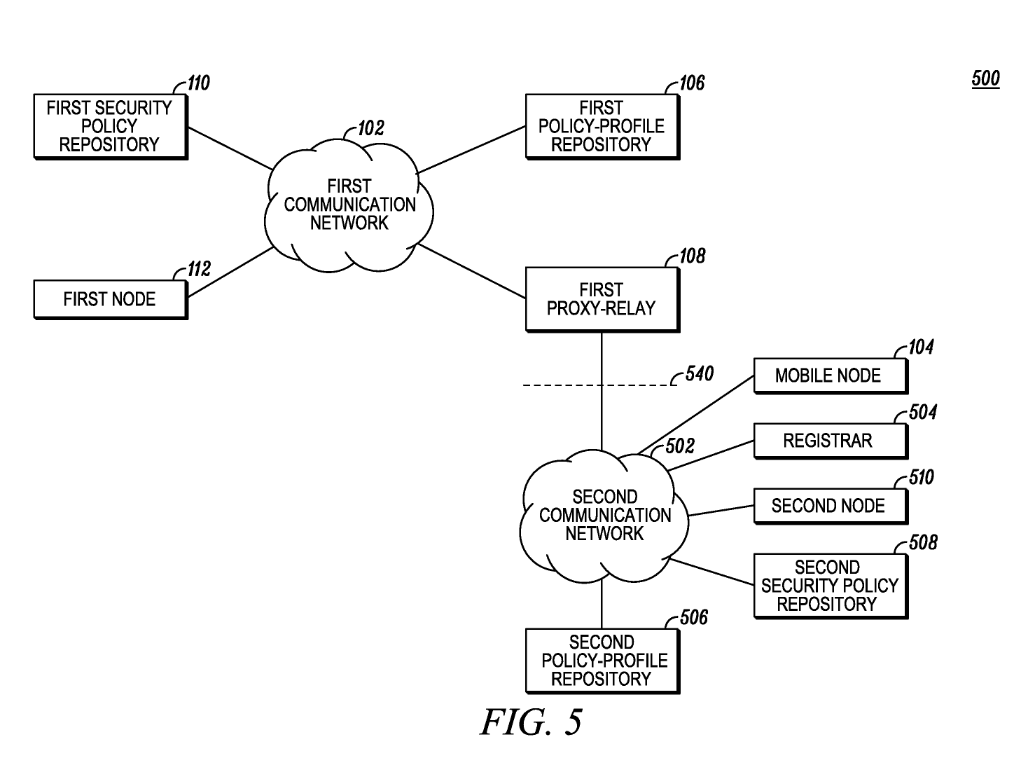

FIG. 5 is a block diagram illustrating a system 500 for managing communication sessions, in accordance with a second embodiment. The system 500 links a second communication network 502 to the first communication network 102 through the proxy-relay 108. The proxy-relay 108 has two interfaces. One interface connects the proxy-relay 108 to the first communication network 102. The other interface connects the proxy-relay 108 to the second communication network 502. The second communication network 502 may be geographically spread over an area such as a building, a campus, a city, etc. Examples of the second communication network 502 include a LAN, a Metropolitan Area Network (MAN), and a Wide Area Network (WAN). For example, the first communication network 102 can be a home network and the second communication network 502 can be the Internet. Typically, there can be one or more gateways, proxies, routers, bridges, and/or firewalls 540 between the second communication network 502 and the proxy-relay 108. Thus, the proxy-relay 108 is capable of acting as a relay between the first communication network 102 and the second communication network 502.

In this second embodiment, the mobile node 104 attaches to the second communication network 502. The mobile node 104 accesses and/or offers services from/to the other nodes attached to the first communication network 102. The system and methods of the second embodiment depict how to manage sessions in a first network that rely on broadcast or multicast messages when the mobile node 104 is not part of the first network or are otherwise outside the domain of the broadcast/multicast messages and where the broadcast/multicast messages can not reach the mobile node 104—nor can the mobile node 104 send broadcast or multicast messages to other nodes in the first network 102.

The second communication network 502 includes the mobile node 104, a registrar 504, a second policy-profile repository 506, and a second security policy repository 508. Further, the communication network 502 includes one or more other nodes, for example, a second node 510. Typically, the mobile node 104 can establish a communication session with the proxy-relay 108 through the second communication network 502. In an embodiment, the communication network 502 assigns a dynamic Internet Protocol (IP) address to its associated nodes, for example, the mobile node 104 and the node 510.

The registrar 504 is associated with the communication network 502 and can be implemented by using a DNS or D-DNS server. The registrar 504 stores the address of the proxy-relay 108. In another embodiment, the registrar 504 is implemented using Session Initiation Protocol (SIP) or a 3G mobile operator's Internet Protocol Multimedia Subsystem (IMS) servers. Typically, the mobile node 104 registers its location with the registrar 504 allowing other nodes to locate the mobile node 104. Typically, the proxy-relay 108 also registers its logical and physical addresses with the registrar 504 to allow the mobile node 104 to locate the proxy-relay 108. In this case, the proxy-relay 108 has one or more interfaces connected to the communication network 502 and each interface has a corresponding logical/physical address. The proxy-relay 108 registers one or more addresses of the interfaces attached to the communication network 502 with the registrar 504.

The second policy-profile repository 506 is communicably coupled to the communication network 502 and operates like the first policy-profile repository 106. The second policy-profile repository 506 stores a second set of policy-profile definitions that describe a second set of services in the communication network 502 that the mobile node 104 is interested to access, services it may offer, and a second set of policy-profile definitions.

The second security policy repository 508 is communicably coupled with the communication network 502 and operates like the first security policy repository 110. In an embodiment, the second security policy repository 508 stores a second set of security policies corresponding to the mobile node 104 and the communication network 502.

The second security policy repository 508 performs an identical role for the second communication network 502 as the first security policy repository 110 provides for the first communication network 102. The second node 510 is associated with the second communication network 502. Examples of the second node 510 include, but are not limited to, computers, printers, scanners, mobile phones, IP phones, CD jukeboxes, set top boxes, and the like.

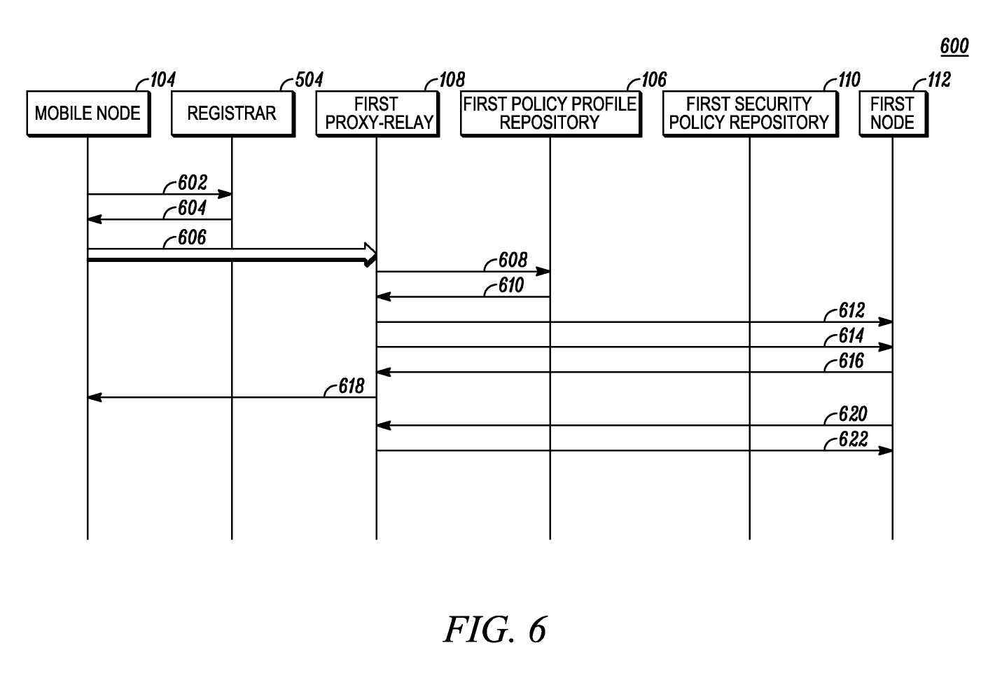

FIG. 6 shows a call-flow diagram 600, in accordance with the second embodiment. For example, the first communication network 102 is a home LAN and the second communication network 502 is the Internet. In this embodiment, the mobile node 104 accesses a service at a first node 112 associated with the first communication network 102 despite the fact it the mobile node 104 is not directly attached with the first network 102. Also, the mobile node 104 can respond to broadcast and multicast messages in the first communication network 102 as if the mobile node 104 was attached to that communication network 102.

Typically after joining the second communication network 502, the mobile node 104 registers its logical identity and its communication address with the registrar 504. After joining the communication network 502, the mobile node 104 sends a message 602 to the registrar 504 to obtain the address of the proxy-relay 108 from the registrar 504. The registrar 504 then sends a message 604 to the mobile node 104 that provides the address of the proxy-relay 108. Thereafter, the mobile node 104 establishes a communication session with the proxy-relay 108 through message group 606. The message group 606 relates to the step 204 of FIG. 2 and is similar to the sequence depicted by messages 406, 408, 410, and 412 of FIG. 4.

Typically, after establishing the communication session, the proxy-relay 108 obtains the policy-profile definitions related to the mobile node 104. In this second embodiment, the mobile node 104 may reference policy-profile definitions stored in the first policy-profile repository 106, the second policy-profile repository 506, or both policy-profile repositories. The mobile node 104 discovers the policy-profile repository 106 using messages similar to messages 414, 416 shown in FIG. 4. In this embodiment, the proxy-relay 108 sends a message 608 to fetch the policy-profile definitions from the policy-profile repository holding the policy-profile definitions applicable to the mobile node 104 in its current circumstances. FIG. 6 shows an example where the policy-profile definitions reside on the first policy-profile repository 106. In this example, the proxy-relay 108 sends the fetch message 608 to fetch the policy-profile definitions from the first policy-profile repository 106. The policy-profile repository 106 sends the requested policy-profile definitions in the form of a message 610. Thereafter, the proxy-relay 108 begins to act as a point of presence, on behalf of the mobile node 104, in the first communication network 102.

Messages 612, 614, 616 and 618 depict the first proxy-relay 108 performing one or more functions on behalf of the mobile node 104. These steps relate to steps 210, 212, and 214 of FIG. 2. The proxy-relay 108 sends a broadcast or multicast offer message 612 to the communication network 102 based on the policy-profile definitions relevant to the mobile node 104. This message 612 informs the first communication network 102 (and other nodes attached to the first communication network 102) about the services offered by the mobile node 104.

The proxy-relay 108 sends a broadcast or multicast access message 614 to the first communication network 102. The access message 614 informs the communication network 102 and the nodes attached to it about the services in the communication network 102 that the mobile node 104 is interested in accessing. Upon receiving the broadcast or multicast access message 614, a node 112 sends a notification message 616 when the node 112 can provide a service the mobile node 104 is allowed to access. On receiving the notification message 616, the proxy-relay 108 forwards it in the form of a message 618 to the mobile node 104. As mentioned previously with respect to FIG. 4, the message 618 can be implemented as a filtered service available message, a series of individual service available messages, or single batch message that aggregates the various service available messages from multiple other nodes.

In another scenario, the node 112 initiates the discovery of a service by sending a service discovery broadcast or multicast message 620 to the communication network 102. Upon receiving the service discovery broadcast or multicast message 620, the proxy-relay 108 determines whether any service offered by the mobile node 104 to the communication network 102 matches the service requested by the other node 112. Typically, the proxy-relay 108 sends a response message 622 to the node 112 on behalf of the mobile node 104. The response message 622 can include at least one pseudo QoS indication along with an address of the mobile node 104. Thereafter, if the node 112 selects the mobile node 104 to fulfill a requested service, the proxy-relay 108 will notify the mobile node 104 (not shown). Typically, communication messages between the mobile node 104 and the other node 112 are sent over the communication network 102 and the communication network 502 going through the plurality of gateways, proxies, routers, bridges, and/or firewalls 540 that may exist. In another embodiment, the proxy-relay 108 tunnels (or relays) all the messages between the mobile node 104 on the second communication network 502 and the node 112 on the first communication network 102.

The communication session between the mobile node 104 and the proxy-relay 108 over the second communication network 502 may be severed during no-activity periods to allow the mobile node 104 to save power. In an embodiment where the proxy-relay 108 needs to re-establish the communication session with the mobile node 104 (where the proxy-relay 108 can not do so and where only the mobile node 104 can re-establish the session with the proxy-relay 108 over the communication network 502 because of firewalls, for example), the proxy-relay 108 sends a notification using an out-of-band message to the mobile node 104 as discussed in the description of FIG. 4. For example, the proxy-relay 108 may send an SMS message, use WAP Push and notification technology, or another notification method. In yet another embodiment, the mobile node 104 may periodically poll the proxy-relay 108 to inquire if there are messages pending. Typically, the communication session between the mobile node 104 and the proxy-relay 108 is based on protocols, for instance, connection-oriented protocols such as TCP or connectionless protocols such as UDP.

The second embodiment, FIG. 5 and FIG. 6, define a system, methods, and examples that describe how a mobile node can discover, offer to, and receive services from other nodes on a first communication network when the mobile node is on a remote communication network and not co-located on the first communication network with the other nodes. In this case, the mobile node 104 cannot send or receive broadcast or multicast messages to/from the other nodes on the first communication network. The mobile node 104 delegates handling such messages to another node (the proxy-relay 108) that can bridge the first communication network with the remote communication network and which is capable of monitoring and processing broadcast and multicast and non-broadcast/multicast messages send over the first communication network.

In a third embodiment, two nodes reside on two distinct communication networks where no messages (broadcast, multicast, and unicast messages) from either of the communication networks can reach the other communication network. A mobile node is attached to yet another communication network. In this embodiment, no single proxy-relay has interfaces on all three networks and there are no trust relationships among existing proxy-relays. The mobile node brokers establishing a link between those two nodes on the two communication networks by establishing a bridging session between two proxy-relays. Using this system and methods, a set of some or all of the nodes on each of the communication networks is able to offer to and access services from all or some of the nodes in the other communication networks. Those skilled in the art will recognize that the system may be extended to include many networks (more than two) coupled to one common network.

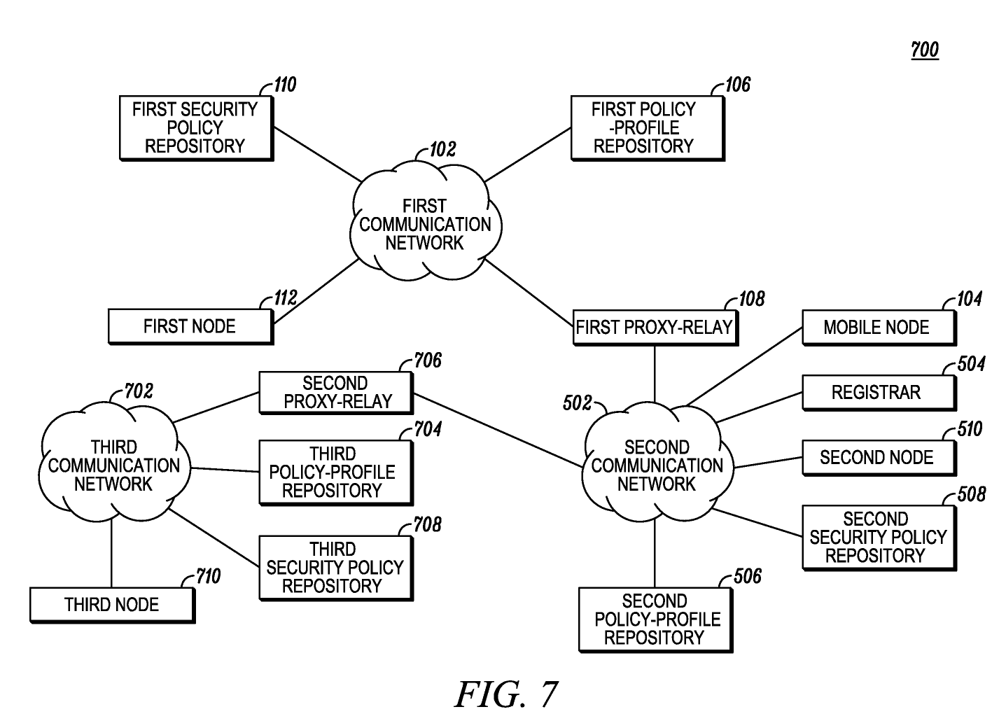

FIG. 7 is a block diagram illustrating a system 700, in accordance with the third embodiment. The system 700 includes a third communication network 702 in addition to the first communication network 102, and the second communication network 502. The third communication network 702 may be geographically spread over an area such as a building. Examples of the third communication network 702 include a LAN and a PAN. In an embodiment, the first communication network 102 is a LAN at home, the second communication network 502 is the Internet, and the third communication network 702 is a LAN at the office.

The third communication network 702 includes a third policy-profile repository 704, a second proxy-relay 706, a third security policy repository 708, and one or more other nodes, for example, a third node 710. The third policy-profile repository 704 stores a third set of policy-profile definitions describing a third set of services in the communication network 702 that the mobile node 104 may be interested in accessing or offering. The second proxy-relay 706 is communicably coupled to both the third communication network 702 and the second communication network 502 to perform one or more functions on behalf of the mobile node 104 in accordance with the third embodiment. Like the other security policy repositories, the third security policy repository 708 stores a third set of security policies corresponding to the mobile node 104. Like the first and second nodes previously described, the third node 710 may be implemented as a computer, mobile phone, printer, scanner, fax machine, IP phone, CD jukebox, set top box, or the like.

The mobile node 104 is attached to the second network 502 and is able to offer and access services provided by the first node 112, the second node 510, and the third node 710. The mobile node 104 is also able to offer services to the nodes 112, 510, and 710 over the first communication network 102, the second communication network 502, and the third communication network 702 in accordance with the first and second embodiments. Further, the mobile node 104 is able to broker a bridging session between the proxy-relays 108, 706 that allows each of nodes 112, 510 and 710 to discover, access, and offer services to each other.

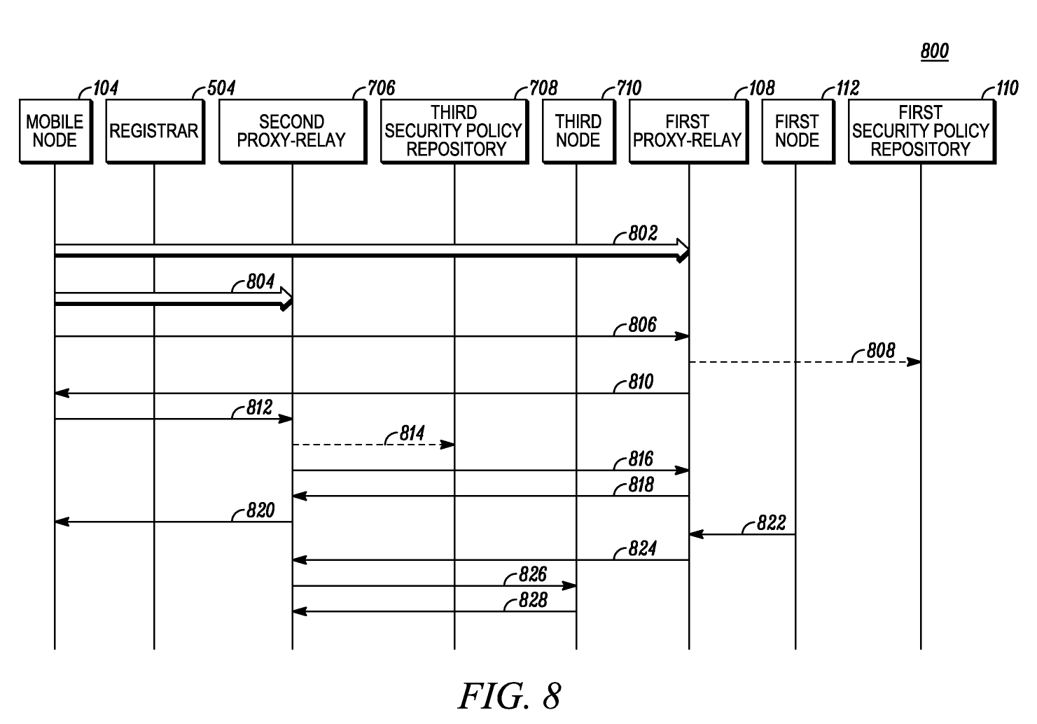

FIG. 8 shows a call-flow diagram 800 depicting the mobile node 104 facilitating a brokering service, in accordance with the third embodiment. Typically, the first proxy-relay 108, the second proxy-relay 706, and the mobile node 104 facilitate a brokering service between the first node 112 associated with the first communication network 102 and the third node 710 associated with the third communication network 702. The brokering service enables the third node 710 to use a service offered by the first node 112. For example, the first node 112 is a printer and the third node 710 is a storage repository storing a file. In this case, the brokering service enables the mobile node 104 to print the file stored in the third node 710 at the first node 112.

The mobile node 104 establishes a first communication session with the proxy-relay 108 (shown as 802). The mobile node 104 establishes the communication session using messages similar to those depicted by messages 602, 604, and 606 in FIG. 6. Thereafter, the mobile node 104 establishes a second communication session with the proxy-relay 706 (shown as 804). The second communication session is also established using messages similar to those depicted by messages 602, 604, and 606 in FIG. 6. The mobile node 104 is establishing two communication sessions to enable a brokering service between the third node 710 and the first node 112.

After establishing the communication sessions with the proxy-relays 108, 706, the mobile node 104 sends a first bridge-session request 806 to the first proxy-relay 108 to establish a two-way bridge session with the first proxy-relay 108. Upon receiving the bridge-session request 806, the proxy-relay 108 sends an optional check-policy message 808 to the first security policy repository 110 to authenticate the mobile node 104, determine if the communication network 102 allows such operations, determine if there are any services that are authorized to be offered or used in such a capacity, and determine if the mobile node 104 is authorized to perform such an brokering operation.

Assuming successful authentication (not shown), the proxy-relay 108 sends a grant message 810 informing the mobile node 104 that a two way bridge session can be established. The mobile node 104 also sends a second bridge-session request 812 to the second proxy-relay 706. (The second bridge-session request 812 may be before or after receipt of the grant message 810.) Thereafter, the second proxy-relay 706 can optionally send a check-policy message 814 to the third security policy repository 708 to authenticate the mobile node 104, determine if the communication network 702 allows such operations, determine if there are any services that are authorized to be offered or used in such a configuration, and determine if the mobile node 104 is authorized to perform such an brokering operation.

After determining that the two-way bridge session can be established (not shown), the second proxy-relay 706 sends a third bridge-session request 816 to the first proxy-relay 108. Thereafter, the first proxy-relay 108 sends a grant message 818 to the second proxy-relay 706. The second proxy-relay 706 forwards the grant message 818 to the mobile node 104 in the form of a grant message 820. Typically, the first proxy-relay 108 and any node of the first network such as the node 112 have no privileges to connect to or send messages to any node of the third communication network 702 such as the proxy-relay 706 or the third node 710. A series of firewalls, network address translators, router and the like would block all communication attempts. Similarly, the second proxy-relay 706 and any node in the third network such as third node 710 have no privileges to connect to or send message to any node of the first communication network 102 such as the first proxy-relay 108, and the first node 112. Therefore, the mobile node 104 will facilitate building a communication path between the first proxy-relay 108 and the second proxy-relay 706 using techniques known to those skilled in the art such as, but not limited to, using a trusted node, such as the second node 510 in the second communication network 502, provisioning network boundary nodes, using SIP session transfer techniques, and the like.

After two-way bridge session is established between the first proxy-relay 108 and the second proxy-relay 706, whenever a node such as the first node 112 broadcasts or multicasts a service query message 822, the first proxy-relay 108 forwards a copy of the service query message 822, in form of message 824, to the second proxy-relay 706. In an embodiment, the first proxy-relay 108 queries the first security policy repository 110 to determine if it may send the forwarding message 824 to the second proxy-relay 706 (not shown).

After receiving the message 824, the second proxy-relay 706 broadcast or multicast a version of the message 824 in form of a message 826 to the third communication network 702. The proxy-relay 706 can send a query to the third security policy repository 708 to determine if it may broadcast or multicast the message 826 (not shown) throughout the third communication network 702. The third node 710 may respond to the message 826 by offering a service in form of a response message 828. The response message 828 is relayed back to the first node 112 via the proxy-relay 706 and the proxy-relay 108 (not shown).

Typically service query messages, such as the service query message 822, and any responses to them, such as the response message 828, use and embed local and private addressing information in accordance with a local communication network-of-origination of these messages. In an embodiment, whenever a node such as the first node 112 initiates a message that will be passed outside of the first network to another network such as the second network, the first proxy-relay 108 generates an external representation (or address) of the first node 112 in accordance with the second communication network 502. Thereafter, the proxy-relay 108 establishes a first internal-to-external point of presence mapping of the first node 112 to the second communication network 502. The first internal-to-external point of presence mapping enables the first node 112 to appear as a node attached to the second communication network 502 even though it is actually remote from the second communication network 502. When the third node 710 responds by sending the response message 828, the second proxy-relay 706 generates an external representation of the third node 710 in accordance with the second communication network 502. This second internal-to-external point of presence mapping is an external representation of the third node 710 exposing it to the second communication network 502 and enables the third node 710 to appear as a node attached to the second communication network 502 even though it is actually remote from the second communication network 502. Thereafter, the second proxy-relay 706 establishes a third internal-to-external point of presence mapping which enables the third node 710 to appear as a node attached to the first communication network 102 (through the second internal-to-external point of presence mapping of the third node 710 from the second communication network 502).

Thereafter, messages that originate from the first communication network 102 use the first internal-to-external mapping to translate addresses and references from an internal (or private) address of the first communication network 102 to an external address of a second communication network 502. Similarly, messages that originate from the third communication network 702 uses the second internal-to-external mapping to translate addresses and references from an internal (or private) address of the third communication network 702 to an external address of the second communication network 502. Next, any messages that originate from the third communication network 702 and are relayed through the second communication network 502 to the first communication network 102 use the third internal-to-external mapping to translate the addresses and references from the second internal-to-external mapping to an external address of the first communication network 102. In another embodiment, messages are tunneled between the various networks. In such a case, some of the addresses may be translated in accordance with a target communication network address. In such a case, each node establishes a point of presence on the other communication network.

In an embodiment, after the mobile node 104 that initiated the bridging session terminates a communication session with either the first proxy-relay 108 or the second proxy-relay 706, the brokering session between the two proxy-relays is terminated. In another embodiment, the system does not terminate the brokering session and allows existing sessions to continue and new sessions between nodes of the first and third communication networks to be established. In yet another embodiment, the system prevents any new session establishments and only allows the current sessions to continue.

In an alternate embodiment, the mobile node 104 may broker a bridging session between the first proxy-relay 108 and the second proxy-relay 706 while the mobile node 104 is connected to the first communication network 102 or the third communication network 702 (rather than the second network). For example, if the mobile node 104 is attached to the first communication network 102, the proxy-relay 108 and/or boundary elements on the first communication network 102 can provide the mobile node 104 an external address in accordance with the second communication network 502. The mobile node 104 uses its internal address to establish a communication session with the first proxy-relay 108. The mobile node 104, using its external address, is able to establish a communication session with the second proxy-relay 706 as if it were attached to the second communication network 502. It should be clear to those skilled in the art that the mobile node 104 may move from the first communication network 102 to the second communication network 502. The communication sessions may move along with the mobile node 104—allowing any bridging sessions between the first communication network 102 and the third communication network 702 to continue.

The third embodiment, FIG. 7 and FIG. 8, define a system, methods, and examples that describe how a mobile node can manage a broadcast or multicast-based session with two otherwise independent communication networks simultaneously while allowing nodes from the otherwise decoupled networks to communicate. For example, a mobile node may access a video server on a first communication network then broker streaming a video file to a video player in a third communication network.

In this document, relational terms such as first and second, and the like, may be used solely to distinguish one entity or action from another entity or action, without necessarily requiring or implying any actual relationship or order between such entities or actions. The terms ‘comprises,’ ‘comprising,’ or any other variation thereof, are intended to cover a non-exclusive inclusion, such that a process, method, article, or apparatus that ‘comprises’ a list of elements includes not only those elements but may include other elements not expressly listed or inherent to such a process, method, article, or apparatus. An element preceded by ‘comprises . . . a’ or ‘comprising . . . a’, does not, without more constraints, preclude the existence of additional identical elements in the process, method, article, or apparatus that comprises the element.

The term ‘another’, as used herein, is defined as at least a second or more. The terms ‘including’ and/or ‘having’, as used herein, are defined as ‘comprising’. The term ‘coupled’ and/or ‘attached’, as used herein, is defined as connected, although not necessarily directly or mechanically. The terms ‘offered’ or ‘interested’, as used herein, is defined as a service request or granting in client-server, peer-to-peer, and distributed network architectures, although not necessarily using common network architectures. The term ‘offered’ exemplifies providing a service as a server does in a client-server architecture, while the term ‘interested’ exemplifies a request to use a service as a client would do in client-server network architecture.

Various embodiments of the invention provide a system and a method for managing communication sessions where discovery and session establishment depends on common broadcast or multicast messaging based protocols. The invention enables a mobile node to continue interacting with a device in a network apart from the network with which the mobile node is directly associated. For example, the mobile node can stream music from a media server in a home network when the node has left the home network. The invention also enables the mobile node to facilitate brokering services across networks. For example, a user of the mobile node goes into a car and becomes a part of the LAN in the car. The invention enables the user to stream music from the media server at home, which is part of the LAN at home, to a media player in the car, which is part of the LAN in the car. Further, the energy consumption of the mobile node is reduced since listening to the broadcast and multicasts of other nodes in the network can be eliminated due to the proxy-relay handling the broadcasts and multicasts and only forwarding the broadcast or multicast messages as directed by policy-profile repository.

It will be appreciated that the method and system for establishing a call in a communication network, described herein, may comprise one or more conventional processors and unique stored program instructions that control the one or more processors, to implement, in conjunction with certain non-processor circuits, some, most, or all of the functions of the system described herein. The non-processor circuits may include, but are not limited to, signal drivers, clock circuits, power-source circuits, and user-input devices. As such, these functions may be interpreted as steps of the method and system for establishing a call or a data link in a communication network. Alternatively, some or all the functions could be implemented by a state machine that has no stored program instructions, or in one or more application-specific integrated circuits (ASICs), in which each function, or some combinations of certain of the functions, are implemented as custom logic. Of course, a combination of the two approaches could also be used. Thus, methods and means for these functions have been described herein.

It is expected that one with ordinary skill, notwithstanding possible significant effort and many design choices, motivated by, for example, the available time, current technology and economic considerations, when guided by the concepts and principles disclosed herein, will be readily capable of manufacturing a device, in accordance with the description, as set out above.

In the foregoing specification, the invention and its benefits and advantages have been described with reference to specific embodiments. However, one with ordinary skill in the art would appreciate that various modifications and changes can be made without departing from the scope of the present invention, as set forth in the claims. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application, and all equivalents of the claims, as issued.

What is claimed is:

1. A system comprising:
a mobile node communicably coupled to a first communication network;
a first proxy-relay communicably coupled to the first communication network for performing one or more functions on behalf of the mobile node; and
a first policy-profile repository communicably coupled to the first communication network for storing a first set of policy-profile definitions describing a first set of services in the first communication network that the mobile node is allowed to access and a first set of rules describing discovery preferences for the mobile node.

2. The system as recited in claim 1, wherein the first policy-profile repository is capable of informing the first communication network about the first set of services.

3. The system as recited in claim 1, wherein the one or more functions are at least one of:
informing the first communication network about the first set of services; and
informing the first communication network about one or more services offered by the mobile node.

4. The system as recited in claim 1 further comprising:
a first security policy repository communicably coupled to the first communication network for storing a first set of security policies applicable to the mobile node.

5. The system as recited in claim 4, wherein the first set of security policies comprise an access control list describing the first set of services that the mobile node is allowed to access.

6. The system as recited in claim 1 further comprising:
a second communication network communicably coupled to the first proxy-relay; and
a second policy-profile repository communicably coupled to the second communication network for storing a second set of policy-profile definitions describing a second set of services in the second communication network that the mobile node is allowed to access.

7. The system as recited in claim 6 further comprising a second security policy repository communicably coupled to the second communication network for storing a second set of security policies applicable to the mobile node.

8. The system as recited in claim 6 further comprising:
a second proxy-relay communicably coupled to the first communication network for performing one or more functions on behalf of the mobile node;
a third communication network communicably coupled to the second proxy-relay; and
a third policy-profile repository communicably coupled to the third communication network for storing a third set of policy-profile definitions describing a third set of services in the third communication network that the mobile node is allowed to access.

9. A policy-profile repository comprising:
an interface to a first communication network; and
a non-volatile memory for storing a first set of policy-profile definitions applicable to a first set of mobile nodes, wherein the first set of policy-profile definitions describe a first set of services that the first set of mobile nodes is allowed to access in the first communication network, and a first set of rules describing discovery preferences applicable to the first set of mobile nodes.

10. A method for a first proxy-relay of a first communication network to manage at least one communication session across one or more communication networks comprising:
establishing a unicast communication session between a mobile node and the first proxy-relay;
obtaining one or more policy-profile definitions, the one or more policy-profile definitions describing one or more services in the first communication network that the mobile node is allowed to access and a first set of rules describing discovery preferences for the mobile node; and
performing one or more functions on behalf of the mobile node in conformance with the one or more policy-profile definitions.

11. The method as recited in claim 10 further comprising:
receiving a policy-profile reference from the mobile node, wherein the policy-profile reference corresponds to one or more policy-profile definitions.

12. The method as recited in claim 10, wherein obtaining comprises:
fetching the one or more policy-profile definitions from one of a first policy-profile repository and a cache of the first proxy-relay.

13. The method as recited in claim 10, wherein performing the one or more functions on behalf of the mobile node comprises:
informing the first communication network about one or more services offered by the mobile node; and
informing the first communication network about one or more services that the mobile node is allowed to access.

14. The method as recited in claim 10, wherein performing comprises:
receiving one or more notification messages from the first communication network regarding one or more services offered by one or more nodes associated with the first communication network;
identifying a first notification message regarding a service that the mobile node is allowed to access from the one or more notification messages; and
providing the first notification message to the mobile node over the unicast communication session.

15. The method as recited in claim 10, wherein performing comprises:
sending a response to a requesting node that is allowed to access at least one service offered by the mobile node, wherein the response provides details of the mobile node to the requesting node.

16. The method as recited in claim 10, wherein performing comprises:
determining a threshold, wherein the threshold is a maximum number of activities in which the mobile node is allowed to participate;
determining a load factor of the mobile node, wherein the load factor indicates a number of activities in which the mobile node is currently participating; and
forwarding one or more messages to the mobile node using the unicast communication session when the load factor is less than the threshold.

17. The method as recited in claim 10 further comprising:
authenticating the mobile node for the first communication network based on policies defined in a first security policy repository of the first communication network.

18. The method as recited in claim 10 further comprising:
facilitating a brokering service between a second node associated with a second communication network and a third node associated with a third communication network, wherein the brokering service enables the third node to use a service offered by the second node.

19. The method as recited in claim 10, wherein performing comprises:
generating a first internal-to-external point of presence mapping for a first node associated with the first communication network, wherein the first internal-to-external point of presence mapping exposes the first node to a second communication network.

20. The method as recited in claim 19 further comprising:
establishing a second internal-to-external point of presence mapping for a third node associated with a third communication network, wherein the second internal-to-external point of presence mapping enables the third node to appear attached to the second communication network;
creating a third internal-to-external point of presence mapping for the third node, wherein the third internal-to-external point of presence mapping enables the third node to appear attached to the first communication network; and
establishing a session between the first node and the third node using the first internal-to-external point of presence mapping, the second internal-to-external point of presence mapping, and the third internal-to-external point of presence mapping.

21. The method as recited in claim 10 wherein establishing comprises:
receiving a broadcast or multicast search message from the mobile node;
transmitting a service announcement message to the mobile node; and
receiving a session request message to establish the unicast communication session.
